(19) United States
(12) Patent Application Publication
(10) Pub. No.: US 2020/0311681 A1
(43) Pub. Date: Oct. 1, 2020

(54) LINKED WORKFLOW STRUCTURE SYSTEMS AND METHODS

(71) Applicant: Construction Materials Technologies, Inc., West Valley, UT (US)

(72) Inventors: Greg Putnam, West Valley, UT (US); Mitchell Harris, West Valley, UT (US); Doug Watson, West Valley, UT (US); Karen Edgar, West Valley, UT (US); John Merrill, West Valley, UT (US)

(73) Assignee: Construction Materials Technologies, Inc., West Valley, UT (US)

(21) Appl. No.: 16/831,622

(22) Filed: Mar. 26, 2020

Related U.S. Application Data
(60) Provisional application No. 62/824,074, filed on Mar. 26, 2019.

(51) Int. Cl. G06Q 10/10; G06F 16/25; G06Q 10/06; G06Q 30/04

(52) U.S. Cl. CPC G06Q 10/103; G06F 16/252; G06Q 10/06313; G06Q 10/0875; G06Q 30/04; G06Q 10/063114; G06Q 10/06316

(57) ABSTRACT

A workflow system includes a workflow database. The workflow database may convert proposals or bids into a workflow process. The workflow process may involve one or more tasks which are performed by resources. The workflow database may have access to systems, or provide a system to interface with resources, contractors, vendors, billing departments, and generate reports of workflow process.

### PRIOIRTY CLAIM

This application claims priority to and benefit of U.S. Provisional Patent Application Ser. No. 62/824,074, filed on Mar. 26, 2019, the contents of which are hereby incorporated in their entirety.

### TECHNICAL FIELD

The disclosure relates generally to systems, methods, and related devices for linking workflow events in an integrated system. In one embodiment, a database system is provided to interface with a plurality of subsystems to monitor workflow events, report the events, identify individuals, equipment, or other requirements associated with the work flow event, and provide a workflow event report on a periodic or real-time basis. Users may have access to the database system through various personal user interfaces.

### BACKGROUND

Every project has a number of associated steps associated with completing the project which must be performed in a more or less particular order, regardless of the complexity of the project. Making dinner, for example, is usually a relatively simple project which results in food being prepared for a meal. However, depending on the food being prepared, various events must occur prior to other events, such as retrieving food from storage in a pantry or refrigerator before preparing the food which occurs before cooking the food, etc. Simple projects may be include relatively few steps or events and even fewer steps or events which are predicated on another step or event (e.g., an oven may or may not need to be turned on before food is prepared as opposed to an oven must be turned on before food can be cooked, if cooking food with the oven). While cooking is a simple example of a workflow, a process which coordinates steps or events into a meaningful logical structure, the cooking process may be an instructive example. Even though cooking dinner, for example, is a simple workflow or workflow process, it can very easily become more complicated. For example, cooking in a restaurant for hundreds of people at the same time may turn a simple workflow into a more complicated workflow. Similarly, cooking a meal for a military base of thousands of people may further complicate workflow, especially when considering multiple meals may be served each day. When considered further in terms of supplying the right kinds of foods for a particular menu, workflow events only expand into more significant logistical tasks. In other words, simple tasks can be easily complicated by significant repetition or by an increase in difficulty, which may find an analogy in cooking a holiday meal, which is typically more elaborate than a non-holiday meal, and therefore more difficult and complex.

Another exemplary workflow may be the construction and materials testing industry. While most construction projects are far from being simple tasks, construction projects are typically a series of simple tasks that are complicated to a point where it is virtually impossible for a single human being or a group of human beings to monitor every aspect of a construction project to ensure that every individual step or event in the process is performed adequately, by the right person, and in a logical pre-determined order of events. Further complicating the matter is that different groups have different specialties for which tasks they are to perform. A paving crew cannot also operate heavy equipment to create a road bed, for example. Thus, since in many circumstances different groups of people with different skills are needed at different parts of the project, it may be difficult to coordinate schedules to keep a project on track and ensure that each crew is ready to execute their particular abilities and skills at a jobsite when the job is to be performed.

Project management has therefore, especially within the last several decades, become a field of academic study which focuses on reducing project costs and how to logistically plan and execute a project. In practice, construction projects have become so complex that teams of project managers are required to monitor a project by receiving daily reports from employees about which projects have been completed and how. However, such an arrangement is disadvantageous because of errors that are introduced by humans, potential fraud or corner cutting, life events for project managers (death, injury, vacation, etc.), and the expense of having a team of project managers watching development of a project.

Governments, whether they be local, state or territory based, provincial, or federal have also created regulations that demand certain reporting requirements for government projects, which adds a significant layer of complexity to workflow management. For example, on highway construction projects, significant numbers and types of tests must be performed at every stage of the construction process to ensure that the highway being built can withstand the strain that may be applied by vehicles to meet jurisdictional requirements. Since the complexity of testing during construction projects is significant by itself, no known efforts have been made to combine acceptance inspection testing and acceptance requirements into the workflow of a construction process. Conventionally, different entities are assigned to construction and materials testing in a situation where construction entities are constrained by material testers and material testers are overrun by construction entities. Both construction and materials testing entities also report to different project managers, in many cases. No single tool has identified workflow events in a manner that requires acceptance inspection testing and construction occur in tandem or in a way that links the performance of one task to performance of another task (e.g., linking performance of a construction task with performance of a acceptance inspection task).

One additional problem in conventional workflow management is monitoring how resources for the projects are allocated between projects. For example, a construction company may have 10 operable front end loaders but may be engaged in several jobs at one time and have need for more than 10 front end loaders on a particular day. Or, another example, is that a company may have two individuals with certifications to perform a certain test but may not have access to those individuals on a particular day. No single tool has brought every element of workflow management into a single tool in a way that combines events with resources in a way that ensures that resources are adequately allocated to meet event objectives.

It is, therefore, one object of this disclosure to provide a comprehensive system for monitoring workflow of every phase of a project for specific events with a particular set of resources in a way that ensures every aspect of project management is being monitored and recorded.

### SUMMARY

Disclosed herein is a workflow system that includes a workflow database. The workflow database may convert proposals or bids into a workflow process. The workflow process may involve one or more tasks which are performed by resources. The workflow database may have access to systems, or provide a system to interface with resources, contractors, vendors, billing departments, and generate reports of workflow process.

In one embodiment, the workflow system may include a workflow database containing a plurality of linked task structures. The workflow system may include a user device associated with a user designated by the workflow system as a performer of at least one task in the plurality of linked task structures. The workflow system may further include an administrator device associated with an administrator user. The workflow database may receive information from a user device about the at least one task, including one or more of a global positioning location of the user device and a time period during which the user is engaged in performing the one or more tasks.

In another embodiment, a method is disclosed. The method includes identifying, by a processor, a plurality of linked task structures, including one or more tasks, associated with a project. The method further includes receiving, from a user device, information about at least one task in the one or more tasks, the information including one or more of the location of the user device based on global positioning location information received from the user device and a time period during which a user is engaged in performing the one or more tasks.

In another embodiment, a non-transitory computer-readable storage media is disclosed. The non-transitory computer-readable storage media may contain instructions, which when executed by a processor causes the processor to perform a method. The method includes identifying, by a processor, a plurality of linked task structures, including one or more tasks, associated with a project. The method further includes receiving, from a user device, information about at least one task in the one or more tasks, the information including one or more of the location of the user device based on global positioning location information received from the user device and a time period during which a user is engaged in performing the one or more tasks.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 illustrates hardware elements of a workflow system;

FIG. 2 illustrates an exemplary implementation of a linked structure;

FIG. 3 illustrates an exemplary report produced by the workflow system;

FIG. 4A/4B illustrates an exemplary audit report for a workflow;

FIG. 5 illustrates a method of connecting a device to the workflow system;

FIG. 6 illustrates a method of initiating command functions for the workflow system;

FIG. 7 illustrates a method of maintaining connectivity for a device to the workflow system;

FIG. 8 illustrates a method of synchronizing workflow between a user device and a workflow system.

### DETAILED DESCRIPTION

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

Before the structure, systems, and methods for workflow systems are disclosed and described, it is to be understood that this disclosure is not limited to the particular structures, configurations, process steps, and materials disclosed herein as such structures, configurations, process steps, and materials may vary somewhat. It is also to be understood that the terminology employed herein is used for the purpose of describing particular embodiments only and is not intended to be limiting since the scope of the disclosure will be limited only by the appended claims and equivalents thereof.

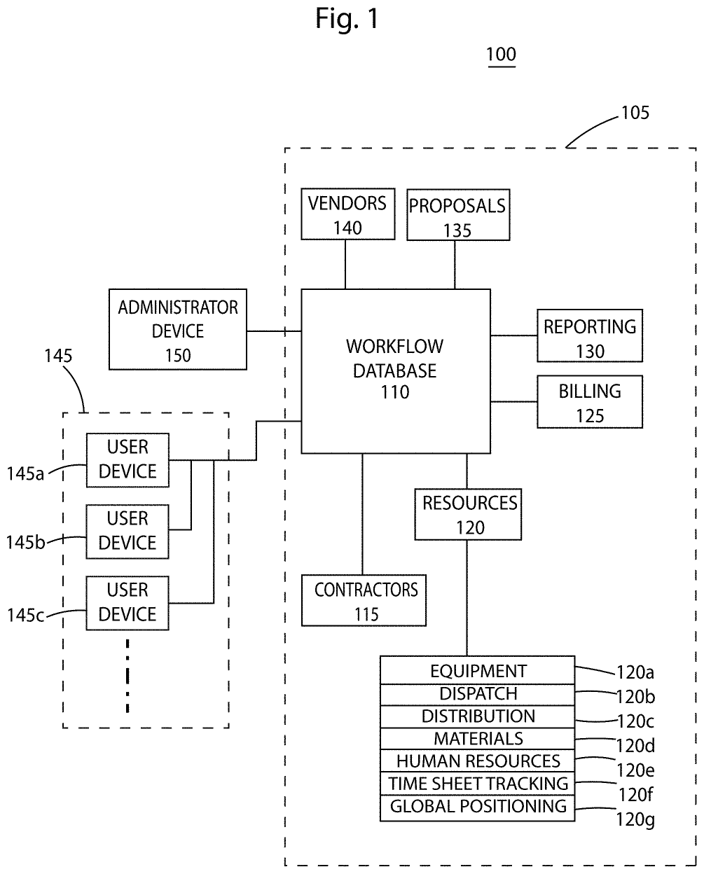

Referring now to the figures, FIG. 1 illustrates hardware elements of a workflow system 100. Workflow system 100 includes a workflow backend system 105. Workflow backend system may include, for example, a workflow database system 110. Workflow database system 110 may be implemented using a computing device. Examples of computing devices include desktop computers, laptop computers, tablets, game consoles, personal computers, notebook computers, and any other electrical computing device with access to processing power sufficient to interact with workflow database system 110. Workflow database system 110, and other devices discussed herein, may include software and hardware modules, sequences of instructions, routines, data structures, display interfaces, and other types of structures that execute computer operations. Further, hardware components may include a combination of Central Processing Units (“CPUs”), buses, volatile and non-volatile memory devices, storage units, non-transitory computer-readable storage media, data processors, processing devices, control devices transmitters, receivers, antennas, transceivers, input devices, output devices, network interface devices, and other types of components that are apparent to those skilled in the art. These hardware components within workflow database 110 may be used to execute the various workflow projects, methods, or algorithms disclosed herein independent of other devices disclosed herein.

Workflow database 110 may be implemented with a single computer or may be networked with a plurality of other computers or computer systems. For example, workflow database 110 may implement a contractors system 115, a resources system 120, a billing system 125, a reporting system 130, a proposal system 135, and/or a vendors system 140. Alternatively, each of contractors system 115, resources system 120, billing system 125, reporting system 130, proposal system 135, and/or vendors system 140 may be individual computers or computer systems that interface with workflow database 110 to exchange computer messages and digital information. Any of contractors system 115, resources system 120, billing system 125, reporting system 130, proposal system 135, and/or vendors system 140 may also be implemented as computing devices or systems of computing devices, as disclosed above, with accompanying hardware components described above.

Workflow database 110 provides a system for workflow management which may or may not incorporate an application program interface. Further, while certain embodiments may be described with reference or example to a particular type of project, workflow database may apply to any project and especially those projects which are too complicated for human direction or management. Finally, it should be noted that any computer system, in addition to those described herein may be appropriate to provide information to workflow database 110 in order to suit a particular embodiment. For example, other systems may be added, as necessary (e.g., an information technology system) to meet the needs of a particular project. The particular systems, such as contractors system 115, a resources system 120, a billing system 125, a reporting system 130, a proposal system 135, and/or a vendors system 140 may or may not be included in workflow database 110 depending on a particular implementation. Workflow system 100 is particularly suitable for construction and materials testing, but is not limited only to this application.

Workflow system 100 allows workflow database 110 to receive and manage information from each of a plurality of systems. For example, in the example of construction materials testing, workflow database 110 may provide minimum sampling and testing reports and audits to ensure that a project meets jurisdictional testing frequency/type compliance, as required by a particular jurisdiction. For example, in one embodiment, workflow database 110 may provide an integrated audit/closeout report, which will be described below in additional detail. However, in order to generate a report, workflow database 110 may receive information from a contractor invoice received through contractors system 115. For example, when a contractor performs a certain task, the contractor may request a payment for the task through contractors system 115. Workflow database 110 may access other records received from, for example, a workflow task list contained within workflow database 110 and information received from user devices 145, which will be discussed in additional detail below. If workflow database 110 is able to validate that the task has been completed, workflow database 110 may provide a message to, for example, a billing system 125 which may both provide payments and generate invoices for the project administrator to bill the project requestor (such as a government entity) for services performed by the contractor. At the same time, workflow database 110 may identify that the particular task has been completed and paid for at a certain time. Workflow database 110 may provide activity codes that identify various different tasks for which contractors may request to be paid through contractors system 115 and may express these tasks in single line descriptions on a per pay item basis. Accordingly, workflow database 110 may provide interactive access through the Internet via a web browser. A vendor may supply a particular set of materials and request payment via vendors system 140 in the same way a contractor may request payment for services, as described above.

Workflow database 110 may further include a resources system 120 which monitors and accounts for all resources available to a company or allocated to a project. Resources may include equipment resources 120a, dispatch resources 120b, distribution resources 120c, materials 120d, human resources 120e, time sheet tracking/payroll 120f, and global positioning resources 120g. Accordingly, workflow database may access information about equipment, the location of equipment, the project location/access to the project site, people available to work on the project, how much time particular people spend on the project, what materials are needed or available for the project, what qualified individuals are necessary for a particular element of a project (e.g., people who have particular training or required certifications) and any other resource necessary to complete a particular project. One advantage of workflow system 100 is to consolidate several different aspects of project management into a single entity, workflow database 110, which consolidates payment, billing, resource access, project reporting and auditing and vendor payments and payment requests into a single workflow database 110.

Proposals system 135 may also be included in workflow database 110. Proposals system 135 allows a company or another entity to bid for a particular set of tasks. Typically, entities, and particularly government entities, solicit bids for a particular project. The request for a bid includes a set of tasks, a list of materials, or requirements for the project. An administrator of workflow database 110 may prepare a bid on a task by task basis to specify what tasks will be performed in what order (e.g., predicate tasks), and what materials will be necessary to meet the project requirements. In this manner, a bid prepared by a company or another entity can be broken down to a cost per task basis and provide a granular explanation of exactly which tasks are being considered and bid to eliminate confusion in what a particular bid did or did not include. When a bid is accepted or approved, the company or other entity may transition the bid into a workflow process in workflow database 110 to ensure that every task that was included in the bid is included in the workflow and then populated with appropriate resources from resource system 120 to meet the requirements of the project. In many cases, a bid may be converted automatically into a workflow process, on a particular schedule, with an accompanying identification of necessary resources to meet the requirements of the project by workflow database 110. When the workflow is accepted by a supervisor, a workflow process is created in which each task is linked in parent-child relationships, which will be discussed in more detail below, to ensure that each task is done in a proper order and no dependent task is assigned or performed before a predicate task is assigned or performed.

Workflow database 110 may generate a linked project structure and resource structure that may account for each task in a bid in a fully customizable manner. Workflow processes may include a series of tasks and sub-tasks and sub-sub-tasks, etc. as required to meet the requirements of a particular bid or project. Each of these tasks, sub-tasks, and sub-sub-tasks may also be allocated on a per task, sub-task, and sub-sub-task level with appropriate resources for accomplishing the particular tasks and which are linked by workflow database 110 to the allocated tasks, sub-tasks, and sub-sub-tasks. Further, available resources may be similarly customizable and linked by the administrator in a particular logistical way that suits a customized need.

Workflow database 110 may further receive information from a plurality of user devices 145, such as user devices 145a, 145b, and 145c. User devices 145 may include any number of user devices, which includes more or fewer user devices than user devices 145a, 145b, and 145c. User devices 145 may be used by employees or other resources at a job site. For example, an employee may be monitoring a construction site and be made aware, via user device 145, that a particular task is to be performed and what the requirements of that particular task are. The employee may then identify that the material used on the task is accurate to the workflow process, sign and upload a document that establishes the material was inspected and approved, and may be immediately uploaded to workflow database 110. User devices 145 may be implemented using any of the computing devices and hardware components discussed above.

Administrator device 150 may also be a computing device and include the hardware components discussed above. However, administrator device 150 may provide administrative access to the workflow process and workflow progress. An administrator may identify using resources, the identification and timing of other resources. For example, an administrator may identify that a particular employee was not at a job site, based on location data (global positioning satellite data, ESRI, ARC GIS data, etc.) of user device 145 at a time when a particular load of gravel substrate was delivered to the jobsite as identified by another resource (e.g., the driver of the delivery truck with the gravel substrate identified a time the gravel substrate is delivered to the jobsite). Such monitoring through the administrator device 150 provides an indication that various tests have been completed as indicated and that test reports for each test are logged as the tests are completed. The administrator device 150 may provide and retrieve any information accessible by workflow database 110. Further, any interface provided by administrator device 150 or user devices 145 may allow input from a user, including form notes, push button/touch screen interfaces, and may be monitored on a version by version basis to ensure document control and any updates are propagated immediately to all other user devices 145 via workflow database 110.

Some jobsites, however, are located in areas where communication resources may be inadequate. For example, many remote areas may lack access to wireless communication networks. If a job site is located in these areas, it may be difficult, if not impossible, to get information in and out of the job site. Accordingly, user devices 145 are configured with automatic synchronization and connection abilities such that user devices 145 may still be useful in communicating workflow data to workflow database 110 at a time when user device 145 is connected and storing new information until such a time as user devices 145 reconnect to workflow database 110. This process will be discussed in further detail below.

User devices 145 may further provide required forms such as forms for government inspectors at a job site, may monitor barcoded samples for laboratory tests, identify particular resources by picture, and provide workflow analysis to a user in real-time.

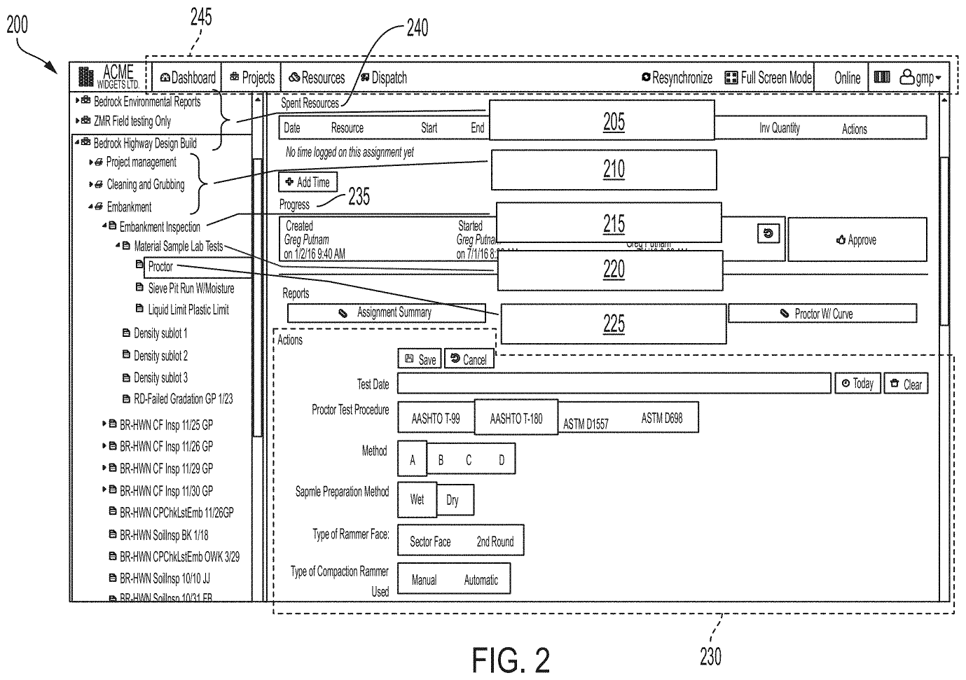

FIG. 2 illustrates an exemplary implementation of a linked structure in a user interface 200. User interface 200 includes a plurality of projects 205 associated with a particular company. Each project is associated with a plurality of tasks 210. As shown in FIG. 2, tasks may be divided into sub-tasks 215, sub-sub-tasks 220, and sub-sub-sub tasks 225. However, this is purely for explanatory purposes. Any number of tasks dependent on a previous task or sub task associated with a particular project may be implemented as necessary. Graphical user interface 200, further includes an input block 230 where a user may input information about the particular task. In this case, the sub-sub-sub-task is to “proctor” which is a task associated with a testing phase of a road bed, for example, A user may be allowed to input information about the test such as the date, procedure selected, method, sample preparation method, and type of compaction required for a test. It is noted that information necessary for each task may be different and that this is only the information that may be associated with a proctor sub-sub-sub task. The larger point is that a user provides information about the task at any sub-task level as appropriate to the particular task.

Graphical user interface 200 may further include a progress block 235 which identifies the user of the graphical user interface and the person preforming the proctor sub-sub-sub task, including identifying “Greg Putnam” as the task performer, a time when the task began, and a time when the task was finished. Greg Putnam may approve the completion of the proctor sub-sub-sub task” when completed by interacting with progress block 235.

Graphical user interface 200 may further provide a resources block 240 which identifies particular resources associated with a particular task. Graphical user interface 200 may further include a plurality of tabs 245 which allow a user to move between a dashboard of workflow, particular projects, resources, and dispatch, as well as options to resynchronize user interface 200 with a workflow system, such as workflow system 100, as shown in FIG. 1, an option to use a full screen mode, an indication that a user device, such as user device 145 which runs graphical user interface 200 is online, and an indication of the person who is using the device.

As previously discussed, each project is associated with tasks, and any number of levels of sub-tasks as shown in FIG. 2 as a workflow process. The workflow process includes identifications of each particular task or sub-task (or levels of sub-task—sub-sub-tasks, etc.) in the workflow and logistically arranges those tasks in an order in which they should be performed. These tasks may be automatically assigned to a particular resource, such as Greg Putnam for performing the required task. This logistical arrangement of tasks is referred to as a linked structure and provides a logical (e.g., a parent/child) relationship for the task such that no dependent task is performed before a predicate task is performed. In more simple terms, the workflow process organizes tasks in a way that provides a tangible test report for a test on a particular section of road bed, for example, is not performed before the section of road bed to be tested is laid.

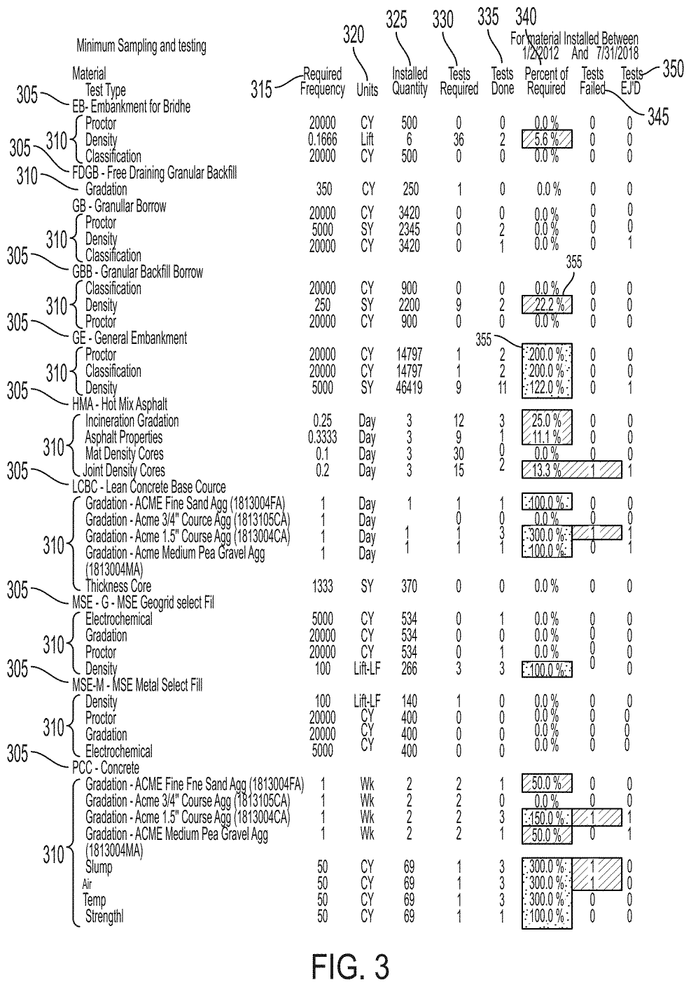

FIG. 3 illustrates an exemplary report 300 produced by a workflow system, such as workflow system 100 shown in FIG. 1. Report 300 is shown as a “minimum sampling and testing” report, which is an example of a number of reports that may be generated by workflow database 110 in workflow system 100. Report 300, in this embodiment, identifies only the testing associated with a particular workflow process for a particular project. Report 300 may include a plurality of exemplary sampling and testing tasks 305 (EB, FDGB, GB, GBB, GE, HMA, LCBC, MSE-G, MSE-M, and PCC). This is not intended to be an exhaustive list and merely identifies a few of the testing tasks 305 which are to be performed for report 300. Each task may have a plurality of sub-tasks 310, as shown in FIG. 3. The report may provide additional information about the required frequency 315 of a particular task 305 and sub-task 310, units 320 for a particular task 305 and sub-task 310, installed quantity 325 of material, for example, for particular task 305 and sub-task 310, number of tests required 330 for a particular task 305 and sub-task 310, number of tests performed 335 for a particular task 305 and sub-task 310, a percentage of required tests accomplished 340 for a particular task 305 and sub-task 310 (e.g., the number of tests required divided by the number tests performed) the number of tests failed 345 for a particular task 305 and sub-task 310, and the number of tests where engineering judgment 350 was applied or required for a particular task 305 and/or sub-task 310.

Notably, report 300 may include graphical indicators 355 which identify a percentage of completion for a particular task/sub-task as it performed. For example, green indicators may identify that a task is complete while red indicators may indicate that a task is lacking a necessary element. The percentages may be provided by workflow system 100 in order to compensate contractors and vendors, for example, according to the percentage of work completed, which in some larger projects is necessary to maintain adequate financial reserves for contractors and vendors.

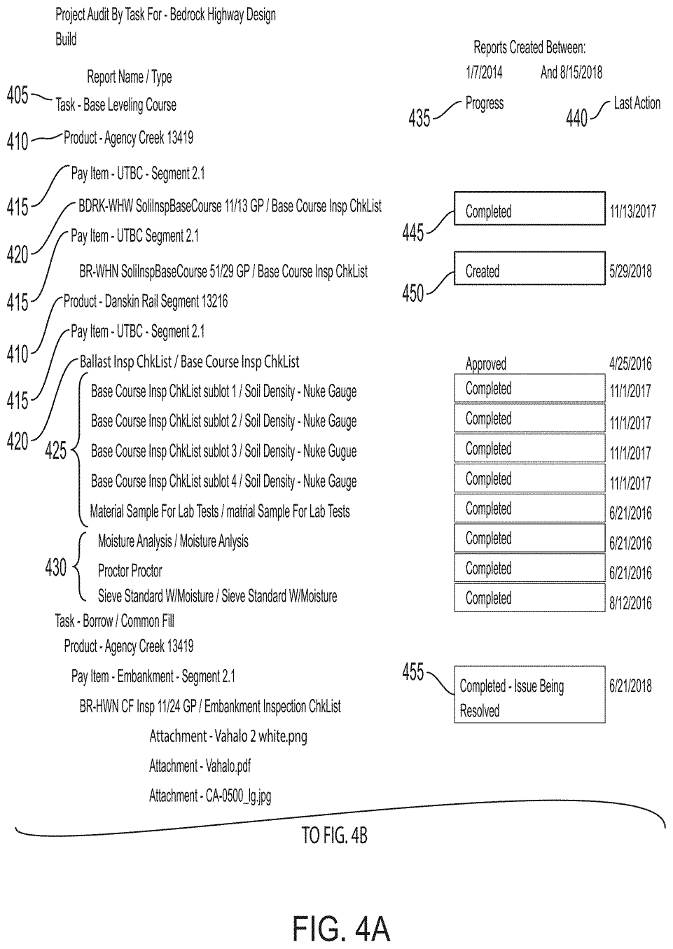

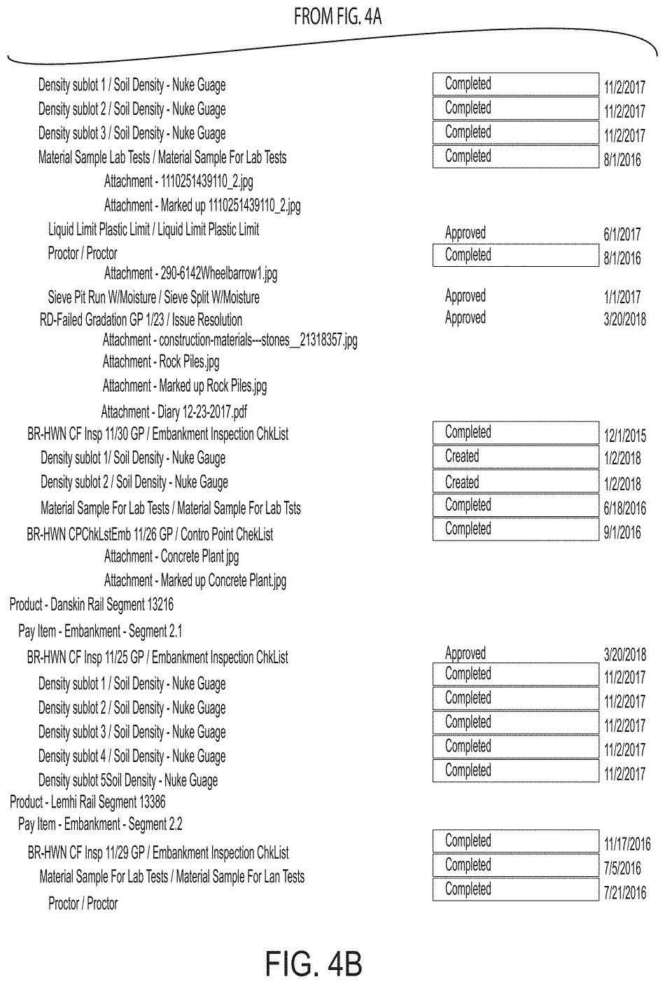

FIGS. 4A/4B illustrate an exemplary audit report 400 for a workflow process, executed by a workflow system, such as workflow system 100, shown in FIG. 1 which may be generated in real-time and on-demand. FIG. 4A illustrates a first portion of audit report 400 which continues in FIG. 4B, as described herein. Audit report 400 includes the entirety of the list of tasks 405, sub-tasks 410, sub-sub-tasks 415, sub-sub-sub-tasks 420, sub-sub-sub-sub-tasks 425, and sub-sub-sub-sub-sub-tasks 430. As previously discussed, any number of tasks and level of sub-tasks may be implemented in a workflow. FIG. 4 merely illustrates one possible arrangement. Audit report 400 may include a progress indicator 435 and a last action indicator 440 identifying, respectively, a level of completion for each project and the last action taken on that project. Further, each individual task 405-430 may be identified as being completed 445, created 450, or a hybrid indicator 455 identifying the progress of the task but indicating that one or more elements of the task need additional resolution.

Audit report 400 may provide an easily understood indication of where a project may be falling behind or may be delayed and show the particular tasks that are delaying a project which allows an administrator to both more quickly realize a delay is developing and take steps to resolve the delay. This audit of the workflow process includes being able to access, through administrator device 150 via workflow database 110 shown in FIG. 1, the particular employees, or other resources that are associated with the task and identify exactly who should be consulted about delays, lack of materials, or other reasons for why particular tasks are delaying the workflow process and the associated project.

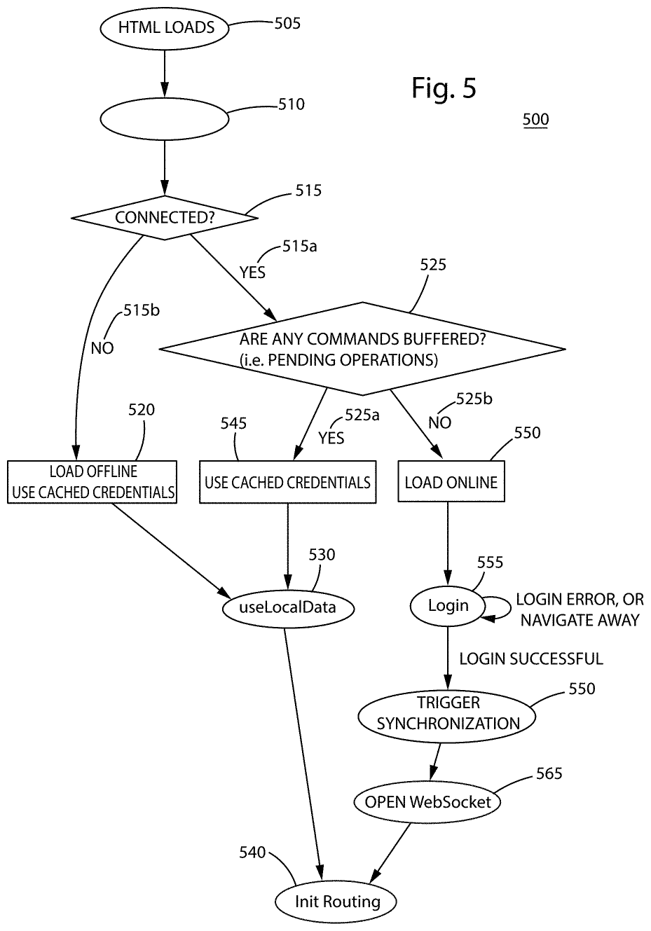

FIG. 5 illustrates a method 500 of connecting a device to a workflow system, such as workflow system 100, shown in FIG. 1. Method 500 may be executed at a time when a device, such as user device 145a may be powered on or when user device 145a has been disconnected from wireless network communication for a period of time. Method 500 begins by loading an HTML library at step 505. Once the HTML library is loaded at step 505, workflow system 100 executes startup at step 510. If user device 145 is unable to connect to a wireless network at step 515, method 500 (step 515b), user device 145a loads offline cached credentials at step 520, uses local data stored on user device 145a for workflow task information at step 530, and initiates routing procedures at step 540.

If user device 145 is able to connect to a wireless network at step 515 (step 515a), user device 145 may determine whether or not any commands sent to the user device have been buffered at step 525. If there are buffered commands (step 525a), user device loads cached credentials at step 545, uses local data stored on user device 145a for workflow task information at step 530, and initiates routing procedures at step 540 until such time as the buffered commands have been resolved and user device may re-execute method 500.

If no buffered commands exist for user device 145, (step 525b), the user device 145 may load the online version of workflow system 100 provide login access at step 555, trigger a synchronization of user device 145 with workflow system 100 at step 550, open a web-socket at step 565, and initiate routing at step 540.

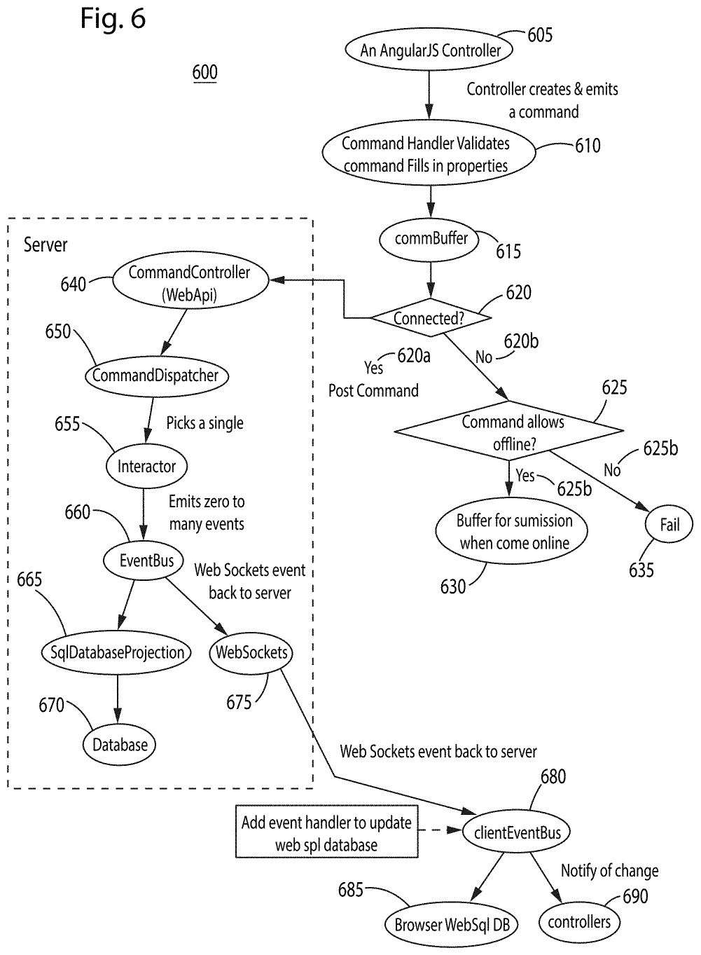

FIG. 6 illustrates a method 600 of initiating command functions for the workflow system between a user device, such as user device 145 and a workflow database 110, shown in FIG. 1. The workflow system begins by initiating a controller 605 to create and emit a command which is validated with associated properties at step 610. Once validated, a communication buffer 615 attempts to contact a server, such as workflow database 110, shown in FIG. 1. At step 620, user device 145 attempts to connect to a server at step 620. If the user device is able to connect to the server (step 620a), the server initiates a web application programming interface (API) at step 640, initiates a command dispatcher at step 650, identifies workflow events with interaction at step 655, sends the events to the event bus at step 660, and stores the events that are sent at step 665 in a database 670. The websockets, at step 675 refer the events back to the server while also communicating the events to the user device 145. The events are handled by the client event bus at step 680 which both provides an indication of a change in workflow database 110 via browser websql database at step 685 or by a controller at step 690.

If user device 145 fails to connect at step 620 (step 620b), user device 145 may determine at step 625 to operate offline at step 630 (step 625b). The workflow event progress information may be buffered and stored until user device 145 may reconnect with a wireless network and exchange information with the server (workflow database 110, for example). Alternatively, if user device 145 cannot accept commands offline, workflow system 600 may fail at step 635.

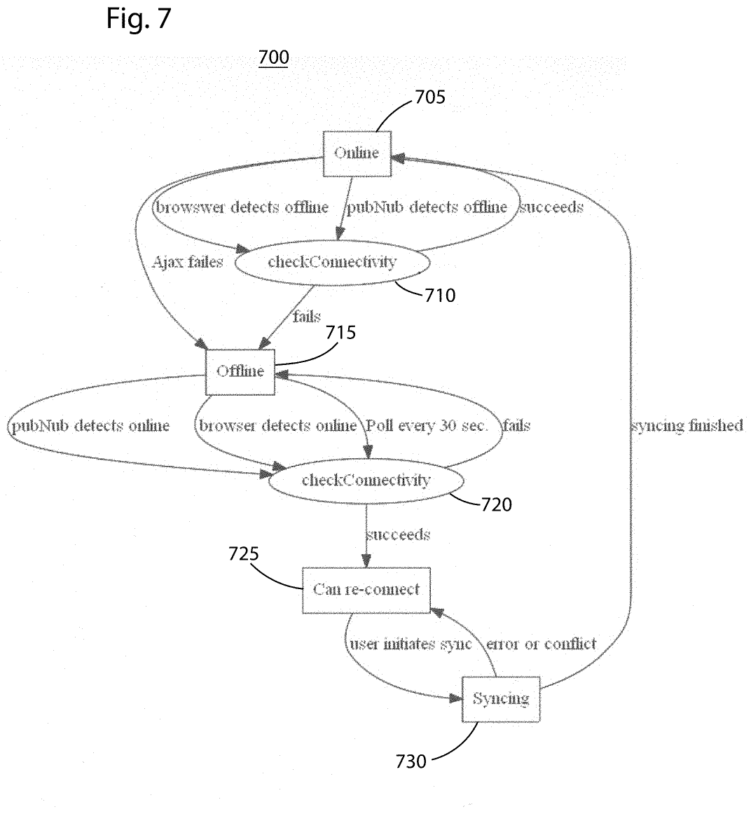

FIG. 7 illustrates a method 700 of maintaining connectivity for a device to the workflow system. Method 700 may be executed by, for example, user device 145, shown in FIG. 1. For example, user device 145 may identify that it is online at step 705 and may, at periodic times, check connectivity with a wireless network at step 710. This check may be periodically performed or may be performed if a pubnub or a browser detects that user device 145 has established connectivity at step 710, which, thereafter, instructs the system to continue periodic connectivity checks. However, if connectivity is not established, or an “ajax” test fails, user device 145 determines that it is offline at step 715. At this point, user device 145 may use the pubnub, browser, or a poll to determine whether or not connectivity has been reestablished at step 720. If connectivity has not been reestablished at step 720, the process returns to step 715 to determine whether or not connectivity is reestablished. In one embodiment, user device 145 may poll the wireless network at a specific interval, such as every 30 seconds, to determine whether connectivity has been reestablished at step 720.

If the user device 145 can reconnect at step 725, user device 145 or a user, may initiate a synchronization step at step 730 to resynchronize user device 145 with a workflow database, such as workflow database 110, shown in FIG. 1. Once user device 145 has completed synchronization at step 730, user device 145 may return to step 705 to monitor online connectivity for user device 145.

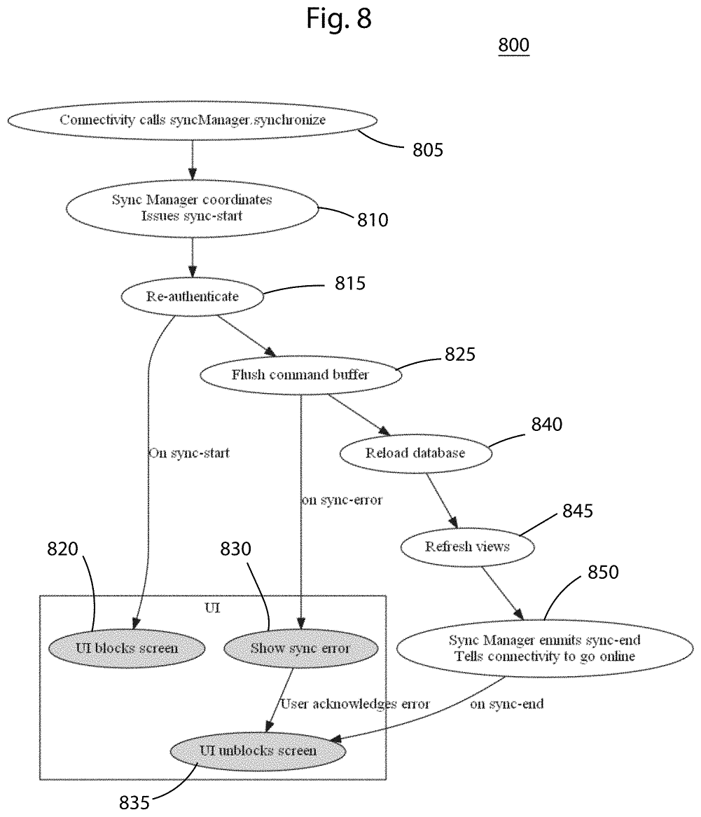

FIG. 8 illustrates a method 800 of synchronizing workflow between a user device, such as user device 145, shown in FIG. 1, and a workflow system, such as workflow database 110, shown in FIG. 1. Method 800 begins at step 805 by determining whether or not user device 145 has requested to synchronize with workflow database 110 at step 805. Workflow database 110 may include a synchronization manager that coordinates and issues a synchronization start at step 810 and may request that the user device reauthenticate itself at step 815. At step 820, the user interface of user device 145 may block access until authentication is provided (e.g., a user name and password are provided). If properly authenticated, workflow database 110 flushes the command buffer at step 825. If a synchronization error is discovered at step 825, the user interface of user device 145 displays a synchronization error at step 830, which is acknowledged by the user (e.g., the user acknowledges understanding that user device 145 is not synchronized), and the user device 145 unblocks access to the user interface at step 835 to allow a user to use user device 145 to accomplish workflow tasks in an offline environment.

However, if step 825 is successful, workflow database 110 may be reloaded at step 840 and refresh the current workflow at step 845. Once synchronization has been performed at step 850, the synchronization manager sends a message to the user device that connectivity has been established. The user interface is unblocked at step 835 and the user may provide access to workflow database 110 and exchange information about workflow events as described above.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. A workflow system, comprising:
a workflow database containing a plurality of linked task structures;
a user device associated with a user designated by the workflow system as a performer of at least one task in the plurality of linked task structures; and
an administrator device associated with an administrator user,
wherein the workflow database receives information from a user device about the at least one task, including one or more of a global positioning location of the user device and a time period during which the user is engaged in performing the one or more tasks.

2. The workflow system of claim 1, wherein the workflow database further includes a list of resources associated with the plurality of linked task structures.

3. The workflow system of claim 2, wherein the resources include equipment resources, dispatch resources, distribution resources, materials resources, human resources, time sheet tracking resources, and global positioning resources.

4. The workflow system of claim 1, wherein the workflow system generates a proposal for the plurality of linked task structures.

5. The workflow system of claim 4, wherein the workflow system converts the proposal into a project hierarchy that includes the plurality of linked task structures as individual tasks necessary to complete a project.

6. The workflow system of claim 1, wherein the user device is wirelessly connected to the workflow database to mutually transmit and receive information in real-time.

7. The workflow system of claim 1, wherein the user device is not wirelessly connected to the workflow database.

8. The workflow system of claim 7, wherein the user device identifies that the user device is not wirelessly connected to the workflow database and stores information to be transmitted to the workflow database until the user device identifies that it has connected to a wireless network and re-connects to the wireless database.

9. The workflow system of claim 1, wherein the workflow database further provides a contractors system which provides an interface that allows a contractor to submit an invoice for payment.

10. The workflow system of claim 9, wherein the contractors system further receives an activity code associated with the one or more tasks.

11. The workflow system of claim 1, wherein the workflow database further provides a billing system which generates invoices for a requestor of the one or more tasks.

12. The workflow system of claim 1, wherein the workflow database further provides a reporting system which tracks completion of the one or more tasks in real-time.

13. The workflow system of claim 12, wherein the reporting system generates a real-time on-demand audit of the one or more tasks.

14. A method, comprising
identifying, by a processor, a plurality of linked task structures, including one or more tasks, associated with a project, and
receiving, from a user device, information about at least one task in the one or more tasks, the information including one or more of the location of the user device based on global positioning location information received from the user device and a time period during which a user is engaged in performing the one or more tasks.

15. The method of claim 14, further comprising:
generating a proposal for the plurality of linked task structures.

16. The method of claim 15, further comprising:
converting the proposal into a project hierarchy that includes the plurality of linked task structures as individual tasks necessary to complete a project.

17. The method of claim 15, further comprising:
storing, on the user device, the information about at least one task in the one or more tasks when the user device is not connected to a wireless network.

18. The method of claim 17, wherein receiving from the user device information about at least one task in the one or more task occurs when the user device reconnects to the wireless network.

19. A non-transitory computer readable storage media containing instructions which when executed by a processor cause the processor to perform a method, the method comprising:
identifying, by a processor, a plurality of linked task structures, including one or more tasks, associated with a project, and
receiving, from a user device, information about at least one task in the one or more tasks, the information including one or more of the location of the user device based on global positioning location information received from the user device and a time period during which a user is engaged in performing the one or more tasks.

20. The non-transitory computer readable storage media of claim 19, further comprising generating a real-time on-demand audit of the project.
